(19) United States
(12) Patent Application Publication
(10) Pub. No.: US 2002/0147797 A1
(43) Pub. Date: Oct. 10, 2002

(54) Discovery and configuration of network attached storage devices

(76) Inventor: Stephen D. Paul, Superior, CO (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/828,540

(22) Filed: Apr. 6, 2001

(51) Int. Cl. G06F 15/177

(52) U.S. Cl. 709/220

(57) ABSTRACT

According to one embodiment of the present invention, software resides on the NAS device itself to automatically look for a Jini lookup service with a specific NAS device domain. Once found, the NAS device registers itself as a NAS storage device with the Jini lookup service. Additionally, software resides on the storage device providing device specific instructions to implement a set of generic commands for interfacing with the device. A generic interface API is provided which all equipped storage devices will implement. This API is device independent. However, the implementation of it on the storage device itself is dependent on the internals of the device. This removes the burden of device specific knowledge from the user. With this implemented the user can configure multiple and diverse storage devices from a generic GUI regardless of the types of devices used. All device specific processing is performed by the device itself.

### FIELD OF THE INVENTION

The invention relates generally to the field of computer networks. More particularly, the invention relates to dynamic discovery and configuration of a device added to a network.

### BACKGROUND OF THE INVENTION

Various methods of maintaining computer networks exist. Sun Microsystems' Jini™ network technology is an example of one such method Jini is a trademark of Sun Microsystems Inc. of Palo Alto, Calif. Jini network technology provides simple mechanisms that enable devices to plug together to form a network. Each device provides services that other devices in the network may use. These devices provide their own interfaces, which ensures reliability and compatibility.

Jini technology uses a lookup service with which devices and services register. When a device plugs in, it goes through an add-in protocol, called discovery and join-in. The device first locates the lookup service (discovery) and then uploads an object that implements all of its services' interfaces (join).

To use a service, a person or a program locates it using the lookup service, a process referred to as lookup. The service's object is copied from the lookup service to the requesting device where it will be used. The lookup service acts as an intermediary to connect a client looking for a service with that service. Once the connection is made, the lookup service is not involved in any of the resulting interactions between that client and that service.

As mentioned above, discovery and join are the processes for adding a service to a system using a lookup service such as Jini. FIG. 1 is a block diagram illustrating standard discovery, registration or join, look-up, and service invocation processes for a system utilizing a lookup service. A service provider 110 is the originator of the service such as a device or software. First, the service provider 110 locates a lookup service 100 by multicasting a request 125. The lookup service 100 responds to the request 125, thereby identifying itself to the service provider 110.

After a lookup service 100 has been located, a service object 130 for the service 110 is loaded into the lookup service 100. This service object 130 contains a public interface for the service 110 including the methods that users and applications will invoke to execute the service 110, along with any other descriptive attributes 135. In the Jini network technology, these public interfaces are Java™ programming language based objects, Java is a Trademark of Sun Microsystems Inc. of Palo Alto, Calif.

A client 105 locates an appropriate service object 130 within a lookup service 100 by searching for the particular type of service. That is, the client 105 searches the lookup service 100 for a particular service 110 identified by its interface or service object 130 written in the Java programming language, along with descriptive service attributes 135 that are used in a user interface. The service object 130 is loaded 120 into the client 105. The final stage is for the client 105 to invoke the service 110.

The client 105 uses the service object 145 obtained from the lookup service 100 to directly access 140 the service provider 110. Such a method allows a client 105 to directly communicate 140 with a service provider 110 using a service object 145 that provides a public interface written specifically for the service provider 110 thereby providing increased scalability and compatability.

However, a few problems exist with such a method. Currently, when adding a new device such as a network attached storage device to the network, the port or IP address of the device must be known in order to configure the device. That is, there is no way to dynamically discover the addition or removal of a device such as a network attached storage device. Additionally, once discovered, there is no way to configure it from a remote site.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 is a block diagram illustrating standard discovery, registration or join, look-up, and service invocation processes for a system utilizing a lookup service;

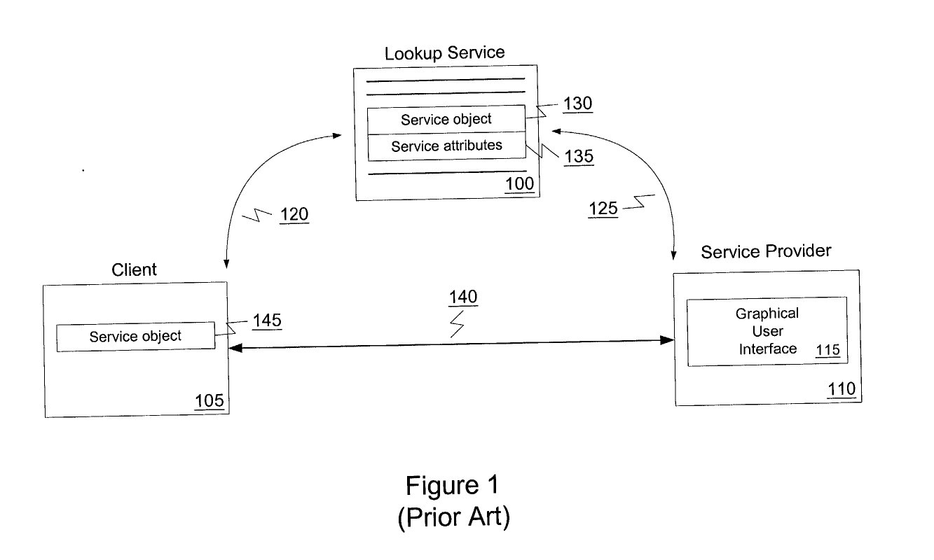

FIG. 2 is a block diagram illustrating an exemplary network upon which the present invention may be implemented;

FIG. 3 is a block diagram illustrating a storage device according to one embodiment of the present invention;

FIG. 4 is a flowchart illustrating a conceptual view of one embodiment of the present invention;

FIG. 5 is a flowchart illustrating processing on a storage device according to one embodiment of the present invention; and

FIG. 6 is a flowchart illustrating processing on an administration terminal according to one embodiment of the present invention.

### DETAILED DESCRIPTION OF THE INVENTION

According to one embodiment of the present invention, software resides on the NAS device itself to automatically look for a Jini lookup service within a specific NAS device domain. Once found, the NAS device registers itself as a NAS device with the Jini lookup service. This allows any client software looking for a registration of this type to dynamically see the addition of the storage device. If the NAS device is removed from the network, the NAS service Jini; lease will expire and all interested parties will be notified of the removal, thus providing the dynamic NAS device removal capability.

Additionally, software resides on the storage device providing device specific instructions to implement a set of generic commands for interfacing with the device. A generic Application Programming Interface (API) is provided which all equipped storage devices will implement. This API is device independent. However, the implementation of it on the storage device itself is dependent on the internals of the device. This removes the burden of device specific knowledge from the user. With this implemented the user can configure multiple and diverse storage devices from a generic Graphical User Interface (GUI) regardless of the types of devices used. All device specific processing is performed by the devices themselves.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Importantly, while embodiments of the present invention will be described with reference to Sun Microsystems Jini network technology, the method and apparatus described herein are equally applicable to other network technologies that provide a network based directory look-up service.

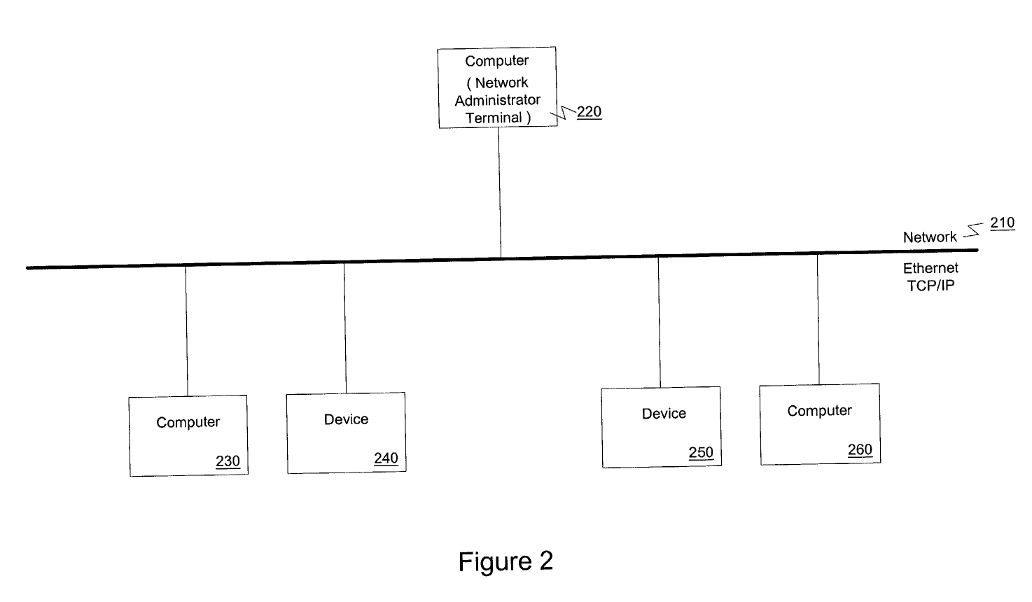

FIG. 2 is a block diagram illustrating an exemplary network upon which the present invention may be implemented. In this example an Ethernet network 210 is shown. Such a network may utilize the common Transmission Control Protocol/Internet Protocol (TCP/IP). Of course, many other types of networks and protocols are available and are commonly used. However, for illustrative purposes, Ethernet and TCP/IP will be referred to.

Connected to this network 210 are computers 220, 230, and 260 and other devices 240 and 250. The computers 220, 230, and 260 may include a network administrator terminal 220. A human operator could use this network administrator terminal 220 to monitor and maintain the network. The devices 240 and 250 may include network attached storage devices or other types of non-terminal devices. The number and arrangement of this equipment may vary depending on the application.

According to one embodiment of the present invention, software resides on the NAS device itself to automatically look for a Jini lookup service within a specific NAS device domain. Once found, the NAS device registers itself as a NAS device with the Jini lookup service. This allows any client software looking for a registration of this type to dynamically see the addition of the storage device. If the NAS device is removed from the network, the NAS service Jini lease will expire and all interested parties will be notified of the removal, thus providing the dynamic NAS device removal capability.

Additionally, software resides on the storage device providing device specific instructions to implement a set of generic commands for interfacing with the device. A generic configuration API is provided which all equipped NAS devices will implement as part of the Jini service. This API is device independent. However, the implementation of it on the NAS device itself is dependent on the internals of the device. This removes the burden of device specific knowledge from the user. With this implemented the user can configure multiple and diverse NAS devices from a generic GUI regardless of the types of devices used. All device specific processing is performed by the devices.

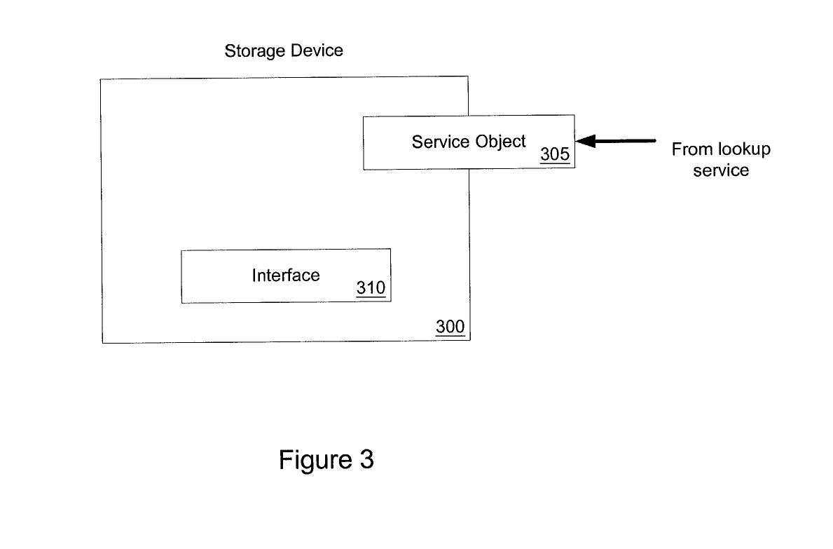

FIG. 3 is a block diagram illustrating a storage device according to one embodiment of the present invention. The storage device 300 is preloaded with interface software 310. This interface software 310 is written specific to the hardware of the device 300 and implements a set of generic commands for interfacing with the device 300. The standard Jini service object 305 received from a look up service can then be used by other devices on the network to access the interface 310 on the storage device 300.

The interface 310 is a set of functions that other devices can use. These functions are very generic and may include functions such as create disk, create file system, delete disk, delete file system, add share, etc. According to one embodiment of the present invention, these functions consist of Java code implemented for a specific device. Advantageously, the Application Program Interface (API) calls to the interface are the same for all devices, regardless of type. Details of processing are hidden from user and performed automatically on the storage device. Therefore, the user need not be concerned about the type of device being used.

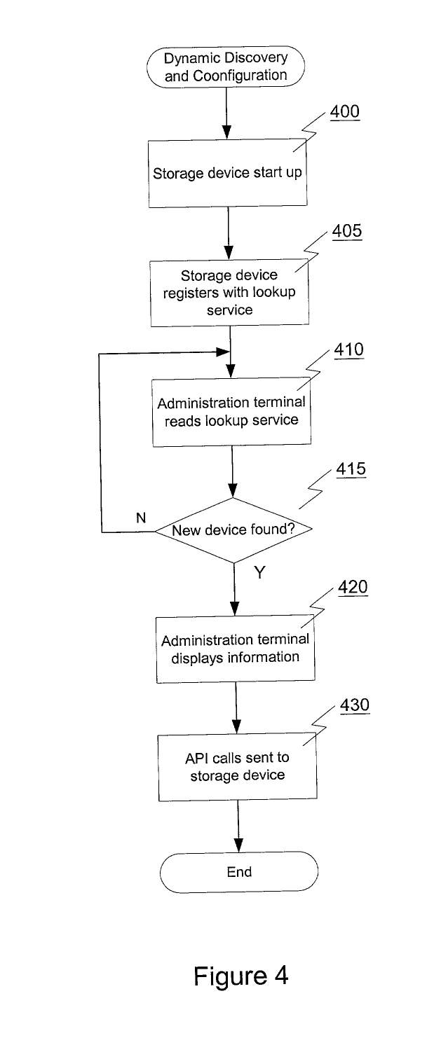

FIG. 4 is a flowchart illustrating a conceptual view of one embodiment of the present invention. Initially, at processing block 400, the storage device is started. This process typically includes starting the operating system of the device and performing all required configuration. Next, at processing block 405, the storage device announces its presence on the network by writing its service object to the lookup service. At processing block 410, the administration terminal reads the lookup service and if a new device is detected at decision block 415, the administration terminal informs a human operator of the presence of the new device through a graphical user interface at processing block 420. If no new device is detected at processing block 415, the administration terminal continues to periodically read the lookup service at processing block 410. Finally, at processing block 430, the administration terminal uses the service object from the lookup service to send API calls to the interface software on the storage device in response to commands from the human operator using the graphical user interface, for example.

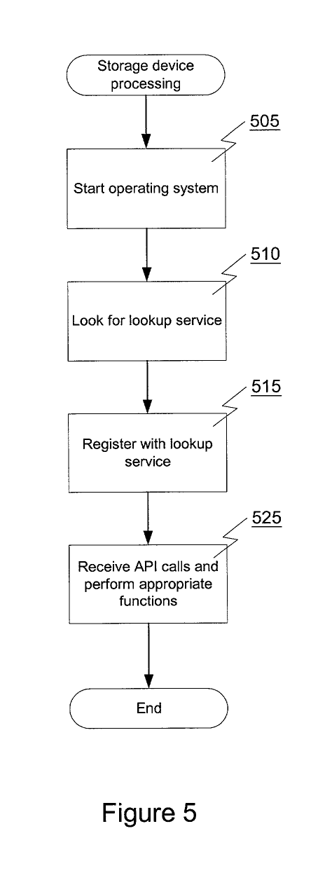

FIG. 5 is a flowchart illustrating processing on a storage device according to one embodiment of the present invention. Initially, once the storage device is connected to the network and powered up, the operating system for the device is started at processing block 505. This process includes performing all necessary setup for using the lookup service. Next, at processing block 510, the device looks for a lookup service on the network. Once a lookup service is located, the storage device registers with the lookup service at processing block 515 by writing its service object and service attributes to the lookup service. Finally, at processing block 525, the storage device receives API calls from an administration terminal and, using the preloaded interface, executes the device specific commands to perform the system calls.

The interface is a set of functions that other devices can use. These functions are very generic and may include functions such as create disk, create file system, delete disk, delete file system, add share, etc. According to one embodiment of the present invention, these functions consist of Java code implemented on a specific device. Advantageously, the interface is the same for all devices. That is, the API calls are the same for all devices, regardless of type. Details of processing are hidden from user and performed automatically on the storage device. Therefore, the user need not be concerned about the type of device being used.

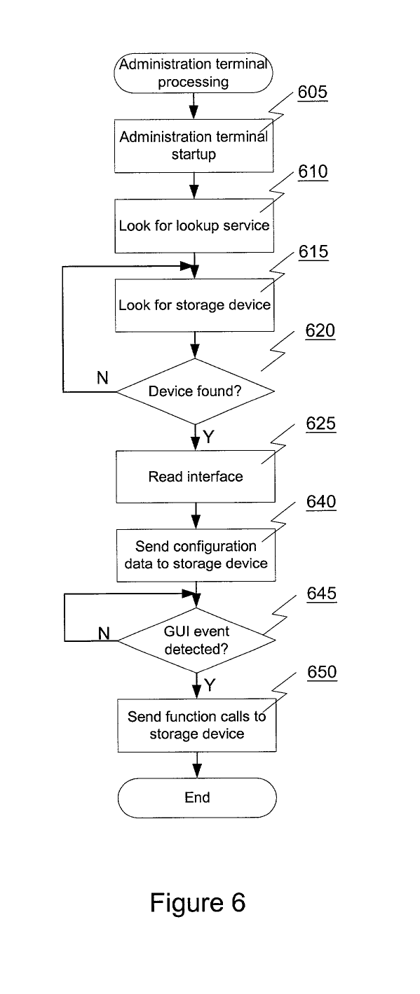

FIG. 6 is a flowchart illustrating processing on an administration terminal according to one embodiment of the present invention. Initially, once the administration terminal is connected to the network and powered up, the operating system for the terminal is started at processing block 605. This process includes performing all necessary setup for using the lookup service. Next, at processing block 610, the administration terminal looks for a lookup service on the network. Once a lookup service is located, the administration terminal, at processing block 615, looks for a storage device with a particular signature.

If a device is not found at decision block 620, the administration terminal periodically rechecks the lookup service at processing block 615. If a device is found at decision block 620, the administration terminal reads the service object from the lookup service at processing block 625 and displays a notification of the presence of a new device to a human operator via a graphical user interface at processing block 630. The administration terminal then waits for an event from the graphical user interface at decision block 645. Such an event may be a human operator clicking a button on the graphical user interface to execute a command on the storage device. Once an event is detected at decision block 645, the administration terminal sends the proper sequence of API calls to the storage device at processing block 650.

According to one embodiment of the present invention, the administration terminal opens a GUI and displays information about the network in tree form with panels and buttons to administrator devices. This GUI provides a graphical interface to allow the use of the public interface functions of the device. The GUI opens panels to display information about the network and allow administration of selected disks. By using this interface, a human operator can configure a number of devices, potentially of different types. The GUI takes button clicks and converts them into a series of function calls to the storage device in the proper sequence so that the user need not be concerned with the lower level commands. So, with simple button clicks, an administrator can create a disk and file system and share files with all users on a network without regard to the type of device being used.

### APPENDIX A

William E. Alford, Reg. No. 37,764; Farzad E. Amini, Reg. No. P42,261; Aloysius T. C. AuYeung, Reg. No. 35,432; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Andrew C. Chen, Reg. No. 43,544: Thomas M. Coester, Reg. No. 39,637; Donna Jo Coningsby, Reg. No. 41.684; Florin Corie, Reg. No. 46,244; Dennis M. deGuzman, Reg. No. 41,702; Stephen M. De Klerk, Reg. No. P46,503; Michael Anthony DeSanctis, Reg. No. 39,957; Daniel M. De Vos, Reg. No. 37,813; Robert Andrew Diehl, Reg. No. 40,992; Sanjeet Dutta, Reg. No. P46,145; Matthew C. Fagan, Reg. No. 37,542: Tarek N. Fahmi, Reg. No. 41,402; Mark Fink, Reg. No. 45,270; George Fountain, Reg. No. 37,374; Paramita Ghosh, Reg. No. 42,806; James Y. Go, Reg. No. 40,621; James A. Henry, Reg. No. 41,064; Libby N. Ho, Reg. No. P46,774; Willmore F. Holbrow III, Reg. No. P41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; Erica W. Kuo, Reg. No. 42,775; George Brian Leavell, Reg. No. 45,436; Gordon R. Lindeen III, Reg. No. 33,192; Jan Carol Little, Reg. No. 41,181; Joseph Lutz, Reg. No. 43,765; Michael J. Mallie, Reg. No. 36,591; Andre L. Marais, under 37 C.F.R. § 10.9(b); Paul A. Mandonsa, Reg. No. 42,879; Clive D. Menezes, Reg, No. 45,493; Chun M. Ng, Reg. No. 36,878; Thien T. Nguyen, Reg. No. 43,835; Thinh V. Nguyen, Reg. No. 42,034; Dennis A. Nicholls, Reg. No. 42,036; Daniel E. Ovanezian, Reg. No. 41,236; Kenneth B. Paley, Reg. No. 38,989; Marina Portnova, Reg. No. P45,750; William F. Ryann, Reg. 44,313; James H. Salter, Reg. No. 35,668; William W. Schaal, Reg. No. 39,018; James C. Scheller, Reg. No. 31,195; Jeffrey Sam Smith, Reg. No. 39,377; Maria McCormack Sobrino, Reg. No. 31,639; Stanley W. Sokoloff, Reg. No. 25,128; Judith A. Szepesi, Reg. No. 39,393; Vincent P. Tassinari, Reg. No. 42,179; Edwin H. Taylor, Reg. No. 25,129; John F. Travis, Reg. No. 43,203; Joseph A. Twarowski, Reg. No. 42,191; Mark Van Ness, Reg. No. 39,865; Tom Van Zandt, Reg. No. 43,219; Lester J. Vincent, Reg. No. 31,460; Brent E. Vecchia, Reg. No. 48,011; Glenn E. Von Tersch, Reg. No. 41,364; John Patrick Ward, Reg. No. 40,216; Mark L. Watson, Reg. No. P46,322; Thomas C. Webster, Reg. No. P46,154; Steven D. Yates, Reg. No. 42,242; and Norman Zafman, Reg. No. 26,250; my patent attorneys, and Firasat Ali, Reg. No. 45,715; and Justin M. Dillon, Reg. No. 42,486; my patent agents, of BLAKELY, SOKOLOFF, TAYLOR & ZAFMAN LLP. with offices located at 12400 Wilshire Boulevard, 7th Floor, Los Angeles, Calif. 90025, telephone (310)207-3800, James R. Thein, Reg. No. 31,710, my patent; and Kenneth Olsen, Reg. No. 26,493; Timothy J. Crean, Reg. No. 37,116; Robert S. Hauser, Reg. No. 37,847; Joseph T. FitzGerald, Reg. No. 33,881; Alexander E. Silverman, Reg. No. 37,940; Christine S. Lam, Reg. No. 37,489; Anirma Rakshpal Gupta, Reg. No. 38,275; Sean Patrick Lewis, Reg. No. 42,798; Michael Schallop, Reg. No. 44,319, Bernice B. Chen, Reg. No. 42,403; Kenta Suzue, Reg. No. 45,145; Noreen Krall, Reg. No. 39,734; Richard J. Lutton, Reg. No. 39,756; Monica Lee, Reg. No. 40,696; Marc D. Foodman, Reg. No. 34,110; Naren Chaganti, Reg. No. 44,602, of SUN MICROSYSTEMS, INC. with full power of substitution and revocation, to prosecute this application and to transact all business in the Patent and Trademark Office connected herewith.

### APPENDIX B

### Title 37, Code of Federal Regulations, Section 1.56 Duty to Disclose Information Material to Patentability

(a) A patent by its very nature is affected with a public interest The public interest is best served, and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclosure information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclosure all information known to be material to patentability is deemed to be satisfied if all information known to be material to patentability of any claim issued in a patent was cited by the Office or submitted to the Office in the manner prescribed by §§ 1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when It is not cumulative to information already of record or being made or record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability,

A prima facie case of unpatentability is established when the information compels a conclusion that a claim is unpatentable under the preponderance of evidence, burden-of-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

What is claimed is:

1. A method of dynamically discovering and configuring a new network device comprising:
registering the new network device with a lookup service;
periodically reading the lookup service from an administration terminal;
responsive to the administration terminal detecting the new network device, notifying a human operator of the presence of the new network device through a graphical user interface on the administration terminal;
responsive to the human operator selecting an option available on the graphical user interface, issuing a series of one or more generic Application Program Interface (API) calls representative of the option to the new network device wherein said API calls cause execution of interface software preloaded on the new network device and contain instructions specific to the new network device for implementing the API calls; and
executing the interface software preloaded on the new device to perform device specific equivalents to the series of one or more generic API calls.

2. The method of claim 1, wherein said interface stored on the new network device comprises a Java language program.

3. The method of claim 1, wherein said options available on the graphical user interface comprise: create disk; create file system; delete disk; delete file system; and share file functions.

4. The method of claim 1, wherein said device is a network attached storage device.

5. The method of claim 1, wherein said lookup service is the Jini lookup service.

6. A method of dynamically configuring a new network device comprising:
preloading the new network device with interface software wherein said interface provides instructions specific to the new network device for executing a set of generic Application Program Interface (API) calls;
registering the new device with a lookup service; and
responsive to receiving API calls, executing the interface software to perform device specific equivalents to the generic API calls.

7. The method of claim 6, wherein said interface stored on the new network device comprises a Java language program.

8. The method of claim 6, wherein said options available on the graphical user interface comprise: create disk; create file system; delete disk; delete file system; and share file functions.

9. The method of claim 6, wherein said device is a network attached storage device.

10. The method of claim 6, wherein said lookup service is the Jini lookup service.

11. A method of dynamically discovering and configuring a new network device comprising:
periodically reading a lookup service to determine whether a new device has been added to the service;
responsive to finding a new device added to the service, reading interface data for the new device from the lookup service and notifying a human operator of the presence of the new network device through a graphical user interface on an administration terminal; and
responsive to the human operator selecting options available on the graphical user interface, sending a series of one or more generic Application Program Interface (API) calls representative of the option to the new network device.

12. The method of claim 11, wherein said interface stored on the new network device comprises a Java language program.

13. The method of claim 11, wherein said options available on the graphical user interface comprise: create disk; create file system; delete disk; delete file system; and share file functions.

14. The method of claim 11, wherein said device is a network attached storage device.

15. The method of claim 11, wherein said lookup service is the Jini lookup service.

16. A Storage Area Network (SAN) system comprising:
a network attached storage (NAS) device coupled with a network and preloaded with interface software providing instructions specific to the NAS device for executing a set of generic Application Program Interface (API) calls; and
an administration terminal coupled with said NAS device via the network and executing software generating a graphical user interface and sending to the NAS device a series of generic Application Program Interface (API) calls representative of options selected from the graphical user interface wherein said API calls are readable by the interface software of the NAS device.

17. The system of claim 16, wherein said interface stored on the NAS device comprises a Java language program.

18. The system of claim 16, wherein said options available on the graphical user interface comprise: create disk; create file system; delete disk; delete file system; and share file functions.

19. A network attached storage (NAS) device coupled with a network and preloaded with interface software providing instructions specific to the NAS device for executing a set of generic Application Program Interface (API) calls.

20. The NAS device of claim 19, wherein said interface stored on the NAS device comprises a Java language program.

21. The NAS device of claim 19, wherein said API calls represent calls for executing commands including: create disk; create file system; delete disk; delete file system; and share file functions.

22. A terminal coupled with a network executing software generating a graphical user interface and sending to a NAS device a series of generic Application Program Interface (API) calls representative of options selected from the graphical user interface wherein said API calls are readable by an interface software the NAS

23. The terminal of claim 22, wherein said API calls represent calls for executing commands including: create disk; create file system; delete disk; delete file system; and share file functions.

24. A machine-readable medium having stored thereon data representing sequences of instructions, the sequences of instructions which, when executed by a processor, cause the processor to dynamically discover and configure a new network device by:
registering the new network device with a lookup service;
periodically reading the lookup service from an administration terminal;
responsive to the administration terminal detecting the new network device, notifying a human operator of the presence of the new network device through a graphical user interface on the administration terminal;
responsive to the human operator selecting options available on the graphical user interface, sending a series of generic Application Program Interface (API) calls representative of the option to the new network device wherein said API calls are readable by interface software preloaded on the new network device and containing instructions specific to the new network device for executing the API calls; and
executing the interface software preloaded on the new device to perform device specific equivalents to the generic API calls.

25. The machine-readable medium of claim 24, wherein said interface stored on the new network device comprises a Java language program.

26. The machine-readable medium of claim 24, wherein said options available on the graphical user interface comprise: create disk; create file system; delete disk; delete file system; and share file functions.

27. The machine-readable medium of claim 24, wherein said device is a network attached storage device.

28. The machine-readable medium of claim 24, wherein said lookup service is the Jini lookup service.

29. A machine-readable medium having stored thereon data representing sequences of instructions, the sequences of instructions which, when executed by a processor, cause the processor to dynamically discover and configure a new network device by:
preloading the new network device with interface software wherein said interface provides instructions specific to the new network device for executing a set of generic Application Program Interface (API) calls;
registering the new device with a lookup service; and
responsive to receiving API calls, executing the interface software to perform device specific equivalents to the generic API calls.

30. The machine-readable medium of claim 29, wherein said interface stored on the new network device comprises a Java language program.

31. The machine-readable medium of claim 29, wherein said options available on the graphical user interface comprise: create disk; create file system; delete disk; delete file system; and share file functions.

32. The machine-readable medium of claim 29, wherein said device is a network attached storage device.

33. The machine-readable medium of claim 29, wherein said lookup service is the Jini lookup service.

34. A machine-readable medium having stored thereon data representing sequences of instructions, the sequences of instructions which, when executed by a processor, cause the processor to dynamically discover and configure a new network device by:
periodically reading a lookup service to determine whether a new device has been added to the service;
responsive to finding a new device added to the service, reading interface data for the new device from the lookup service and notifying a human operator of the presence of the new network device through a graphical user interface on the administration terminal; and
responsive to the human operator selecting options available on the graphical user interface, sending a series of generic Application Program Interface (API) calls representative of the option to the new network device.

35. The machine-readable medium of claim 34, wherein said interface stored on the new network device comprises a Java language program.

36. The machine-readable medium of claim 34, wherein said options available on the graphical user interface comprise: create disk; create file system; delete disk; delete file system; and share file functions.

37. The machine-readable medium of claim 34, wherein said device is a network attached storage device.

38. The machine-readable medium of claim 34, wherein said lookup service is the Jini lookup service.
